(19) United States
(12) Patent Application Publication
(10) Pub. No.: US 2008/0286177 A1
(43) Pub. Date: Nov. 20, 2008

(54) Reactor with differentially distributed catalytic activity

(75) Inventor: Jonathan Jay Feinstein, North Salem, NY (US)

Correspondence Address: FRISHAUF, HOLTZ, GOODMAN & CHICK, PC, 220 Fifth Avenue, 16TH Floor, NEW YORK, NY, 10001-7708, US

(73) Assignee: Tribute Creations, LLC, Farmington, CT (US)

(21) Appl. No.: 12/152,228

(22) Filed: May 13, 2008

Related U.S. Application Data
(60) Provisional application No. 60/930,830, filed on May 18, 2007.

(51) Int. Cl. B01J 19/00

(52) U.S. Cl. 422/216

(57) ABSTRACT

A catalytic reactor in which higher catalytic activity is distributed proximate to the reactor wall than remote from the reactor wall to provide a greater heat source in the case of exothermic reactions or greater heat sink in the case of endothermic reactions proximate to the reactor wall to increase the temperature gradient and heat transfer between the reactor wall and the internal volume of the reactor.

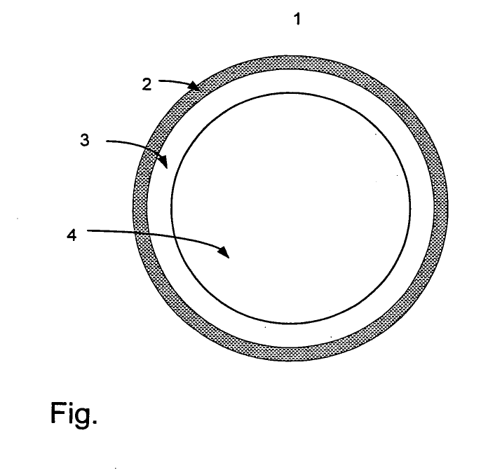

### CROSS-REFERENCE TO RELATED APPLICATION

This application claims the benefit under 35 USC 119 of U.S. Provisional Patent Application Ser. No. 60/930,830 filed May 18, 2007, the entire contents of which is incorporated herein by reference.

### FIELD OF INVENTION

The present invention pertains to the field of catalysis.

### BACKGROUND INFORMATION

Catalytic reactors are sometimes used for non-adiabatic processing. A first type of such non-adiabatic catalytic reactor is for exothermic reactions. In this first type the reactor has dual functions of promoting the chemical reaction while transferring heat from the reacting species to control the process temperature. Such process control may be desirable to protect the reactor from damage from overheating or exploding or to improve the selectivity of the catalytic process. A second type of non-adiabatic catalytic reactor is for endothermic reactions for which the reactor must both promote the chemical reaction and promote the transfer of heat to the reacting species. In the second type, heat transfer is necessary to sustain the intended endothermic reaction. The term “Reactor” as used herein shall refer collectively to endothermic and exothermic non-adiabatic catalytic reactors.

The Reactors are often in the form of shell and tube heat exchangers in which the tubes contain a catalyst. Because of the limited heat transfer into or out of the tubes, the tubes' ratio of surface area to volume must be high, resulting in higher costs associated with many tubes of small diameter.

It is known that both relatively higher catalytic activity and higher convective heat transfer promote relatively higher heat transfer into or out of Reactors. In the case of exothermic reactions the relatively higher catalytic activity acts as a more effective heat source. In the case of endothermic reactions the relatively higher catalytic activity acts as a more effective heat sink. Although the mechanisms are equally applicable to endothermic and exothermic catalytic reactions, endothermic reactions will be discussed as exemplary.

For endothermic reactions, heat transfer into the Reactor is promoted in part by convection of fluids between the relatively hot, externally heated Reactor walls and the cooler areas nearer the axis of the Reactor. The heat flux is proportional to the radial temperature gradient. In the absence of catalytic activity within the Reactor, a certain radial temperature gradient would be established. The addition of catalytic promotion of an endothermic reaction provides a heat sink, cooling the fluid within the Reactor. This increases the heat flux above what it would be in the absence of such catalytic activity. Radial temperature gradients at catalytic reaction sites near the center of the Reactor are diminished, however, resulting in the more interior regions receiving a lower heat flux to promote the endothermic reaction in those more interior regions. This is consistent with optimal Reactor performance because, just as smaller diameter Reactors require less heat flux to support reactions because of their higher surface area to volume, lower radial heat flux is required nearer the axis of a Reactor than at the reactor wall.

The catalyst within Reactors is often in the form of randomly packed beds of particles containing active catalytic species. These particles have a uniform content of active catalytic species, so the availability of catalytic activity across the radius of the Reactor is generally uniform, with the exception noted in the following sentence. Randomly packed beds experience lower-than-average packing density near the Reactor wall, known as the wall effect. As a result, the availability of catalytic activity (and therefore catalytic heat sink or heat source) near the Reactor wall is actually below the average for the entire Reactor. This means that heat transfer in these Reactors is not optimal. Further, the particle size in randomly packed beds may be determined by considerations other than heat transfer, such as pressure drop or structural strength, resulting in larger particles with less active catalytic surfaces than would be desired for heat transfer purposes alone.

Monolithic catalytic packings utilizing an engineered substrate coated with active catalytic species can be used in place of randomly packed beds to circumvent the disadvantage of depressed catalytic activity near the reactor wall that is associated with randomly packed beds. Only monoliths providing radial communication of flow passages from the wall to the axis of the Reactor and promoting radial flow or mixing, however, have good potential to promote greater radial heat transfer than randomly packed beds. U.S. Pat. Nos. 4,340,501, 4,719,090, 4,882,130, 4,985,230, 5,350,566, 6,534,022 B1, and 6,667,017 B2 and U.S. patent application 60/630,492 (now U.S. application Ser. No. 11/796,273), the entire disclosure of each of which is incorporated herein by reference in its entirety, are examples of prior art providing transverse communication and promotion of transverse flow in catalytic reactors using monoliths. No prior art teaches differentiated catalytic activity as a function of distance either in the radial direction or from the Reactor wall.

U.S. patent application 60/630,492 provides for two distinct volumes within a reactor. A core is defined near the Reactor axis, and a casing is defined between the core and the Reactor wall. Although this application anticipates various criteria to affect radial convective heat transfer and other intents, it does not anticipate the preferential distribution of higher catalytic activity nearer the reactor wall than in regions nearer to the reactor axis.

### SUMMARY OF THE INVENTION

It is an objective of the present invention to increase the effective heat transfer properties of a Reactor by increasing the catalytic activity near the Reactor wall relative to the catalytic activity in the balance of the Reactor.

In accordance with one embodiment, a catalytic reactor comprises an inlet, an outlet, a reactor axis, a reactor wall being disposed about the reactor axis, a core disposed at least proximate to the reactor axis and having a plurality of passages for passage of fluid there through, and a casing disposed between the core structure and the reactor wall, the casing structure having a plurality of passages for passage of fluid there through and having higher catalytic activity than the core structure.

In accordance with another embodiment, there is disclosed a catalytic packing for use in a catalytic reactor in which the catalytic reactor comprises an inlet, an outlet, a reactor axis, a reactor wall being disposed about the reactor axis, a core disposed at least proximate to the reactor axis and having a plurality of passages for passage of fluid there through, and a casing disposed between the core structure and the reactor wall, the casing structure having a plurality of passages for passage of fluid there through and having a higher catalytic activity than the core structure.

These and other features and advantages of the invention will now be described with reference to the drawing of a certain preferred embodiment, which is intended to illustrate and not to limit the invention, and in which like reference numbers represent corresponding parts throughout.

### BRIEF DESCRIPTION OF THE DRAWING

The FIGURE illustrates a transverse section of a Reactor according to the present invention.

### DETAILED DESCRIPTION OF THE INVENTION

The following detailed description discloses various exemplary embodiments and features of the invention. These exemplary embodiments and features are not meant to be limiting.

The present invention is a catalytic Reactor comprising an inlet, an outlet, a Reactor axis, a Reactor wall disposed about the Reactor axis, a core structure disposed at least proximate to the Reactor axis and having a plurality of passages for passage of fluid there through, a casing structure disposed between the core structure and the Reactor wall, the casing structure having a plurality of passages for passage of fluid there through and having higher catalytic activity than the core structure.

While not being confined to the following explanation, it is thought that reducing the distance heat must flow from a Reactor wall to reach active catalyst tends to increase the heat flux. Provision of lower catalytic activity in remote regions from the Reactor wall can provide advantages of consuming less catalytically active species, consuming less expensive catalytically active species, providing lower pressure drop through the Reactor or providing more control of reactions or more uniform temperature and selectivity throughout the Reactor.

Referring to the FIGURE, a transverse section of a catalytic Reactor according to the present invention, catalytic Reactor 1 comprises a Reactor wall 2, a casing 3 and a core 4.

The diameter of the core may be between about 0.1 and 0.99 times the inside diameter of the Reactor wall, and the casing occupies the remaining volume of the Reactor inside the Reactor wall. The core may not be cylindrical. The distance between the core and the Reactor wall may vary within a given transverse section or along the length of the Reactor, but a cylindrical core at a constant distance from the Reactor wall throughout the Reactor is generally anticipated to be suitable. The core is preferably cylindrical, having a diameter in the range of about 0.5 to 0.9 times the inside diameter of the Reactor wall.

The core may consist of a randomly packed bed or a monolith containing a catalyst. The casing may consist of a randomly packed bed or a monolith containing a catalyst. Monoliths may incorporate ceramic or metal substrates coated with or comprising a catalyst. In the embodiment in which the core and casing both consist of randomly packed beds, a smaller particle size in the casing than in the core would constitute one method of providing higher catalytic activity in the casing than in the core.

The Reactor may include more than one casing surrounding a core in which the casings closer to the axis have lower catalytic activity than those casings further from the axis. The catalytic activity may vary in steps or continuously between the axis and the Reactor wall.

The activity of the catalyst may be increased in a variety of ways taught in most catalysis books, including the book entitled “Catalytic Air Pollution Control” by R. M. Heck and R. J. Farrauto published by John Wiley & Sons, Inc., the entire disclosure of which is incorporated herein by reference.

The catalytic activity in the casing may be increased relative to the catalytic activity in the core in various ways including the following. The catalyst in the casing may incorporate a composition of matter that promotes the desired reaction with a lower activation energy than in the core, or may contain higher loadings of the active catalyst to give the casing relatively higher activity. The catalyst in the casing may be dispersed to have greater surface area of the active catalyst than in the core. One method of increasing the dispersion of active catalyst to have higher surface area is by applying the catalyst throughout a thicker support structure or coating. The casing may contain a porous support structure that permits greater fluid transport there through than in the support in the core to give the casing increased activity relative to the core. Porous structures of higher specific pore volume or larger pore diameters are known examples. The substrate in the casing may have higher GSA than the substrate in the core, where GSA is defined as the area of catalytic surfaces divided by the volume of the reactor without consideration of surfaces within internal pores.

It is preferred that the casing and core are both monolithic. It is preferred to combine the present invention with the art described in U.S. patent application 60/630,492, the contents of which are incorporated by reference in its entirety.

The present invention is believed to be useful for endothermic reactions including steam methane reforming, in which steam and a hydrocarbon are reacted in the presence of a catalyst to form gas mixtures containing hydrogen. Such endothermic process can be constrained by the heat transfer properties of the catalytic reactor, limiting throughput. The present invention is also believed to be useful for exothermic reactions including methanation and hydrogenation. Such exothermic processes can be constrained by heat transfer, the lack thereof resulting in overheating, loss of selectivity, explosions or other forms of damage to the reactor.

The above embodiments are to be understood as illustrative and non-limiting examples of the invention. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

I claim:

1. A catalytic reactor comprising:
an inlet,
an outlet,
a reactor axis,
a reactor wall being disposed about the reactor axis,
a core disposed at least proximate to the reactor axis and having a plurality of passages for passage of fluid there through, and
a casing disposed between the core structure and the reactor wall, the casing structure having a plurality of passages for passage of fluid there through and having higher catalytic activity than the core structure.

2. The reactor of claim 1, wherein the catalytic activity in the casing is rendered higher than the catalytic activity in the core by virtue of the casing having at least one of the following differences relative to the core; a) use of catalytically active species that have lower activation energy for the desired reaction, b) higher loading of catalytically active species, b) greater surface area of catalytically active species, d) increased pore surface area in the support, e) increased geometric surface area.

3. The reactor of claim 1, wherein the core is at least one of a randomly packed bed and a monolith.

4. The reactor of claim 1, wherein the casing is at least one of a randomly packed bed and a monolith.

5. The reactor of claim 1, wherein the casing is a monolith incorporating a substrate composed of at least one of a ceramic and a metal.

6. The reactor of claim 1, wherein the core is a monolith incorporating a substrate composed of at least one of a ceramic and a metal.

7. The reactor of claim 1, wherein the reactor is used for reforming steam and a hydrocarbon to produce a gas mixture containing hydrogen.

8. The reactor of claim 1, wherein the reactor is used for one of hydrogenation and methanation.

9. A catalytic packing for use in a catalytic reactor in which the catalytic reactor comprises:
an inlet,
an outlet,
a reactor axis,
a reactor wall being disposed about the reactor axis,
a core disposed at least proximate to the reactor axis and having a plurality of passages for passage of fluid there through, and
a casing disposed between the core structure and the reactor wall, the casing structure having a plurality of passages for passage of fluid there through and having higher catalytic activity than the core structure.

10. The catalytic packing of claim 9, wherein the catalytic activity in the casing is rendered higher than the catalytic activity in the core by virtue of the casing having at least one of the following differences relative to the core; a) use of catalytically active species that have lower activation energy for the desired reaction, b) higher loading of catalytically active species, b) greater surface area of catalytically active species, d) increased pore surface area in the support, e) increased geometric surface area.

11. The catalytic packing of claim 9, wherein the core is at least one of a randomly packed bed and a monolith.

12. The catalytic packing of claim 9, wherein the casing is at least one of a randomly packed bed and a monolith.

13. The catalytic packing of claim 9, wherein the casing is a monolith incorporating a substrate composed of at least one of a ceramic and a metal.

14. The catalytic packing of claim 9, wherein the core is a monolith incorporating a substrate composed of at least one of a ceramic and a metal.

15. The catalytic packing of claim 9, wherein the reactor is used for reforming steam and a hydrocarbon to produce a gas mixture containing hydrogen.

16. The catalytic packing of claim 9, wherein the reactor is used for one of hydrogenation and methanation.
